(19) United States
(12) Patent Application Publication
(10) Pub. No.: US 2010/0277328 A1
(43) Pub. Date: Nov. 4, 2010

(54) FORCE-SENSITIVE PRESENCE DETECTORS AND METHODS OF DETECTING PRESENCE

(76) Inventors: Deborah D. Mullan, Danville, CA (US); James B. Doyle, Tewksbury, MA (US)

Correspondence Address: MILLS & ONELLO LLP, ELEVEN BEACON STREET, SUITE 605, BOSTON, MA, 02108, US

(21) Appl. No.: 12/773,354

(22) Filed: May 4, 2010

Related U.S. Application Data
(60) Provisional application No. 61/175,225, filed on May 4, 2009.

(51) Int. Cl. G08B 21/00

(52) U.S. Cl. 340/665

(57) ABSTRACT

A force-sensitive presence detection system, detector, and detection method are provided. The detector includes a substantially flat water-proof enclosure, having disposed therein an electrically isolating layer disposed between first and second conductive layers, wherein the electrically isolating layer has a plurality of contact regions formed therein to enable the first and second conductive layers to electrically couple in response to an application of a force thereto. A signaling device is configured to output a time-based signal to a receiver when the first and second conductive layers electrically couple. A method of detecting a body using the detector is also provided.

### FIELD OF THE INVENTION

The present inventive concepts relate to force-sensitive presence detectors and methods of detecting a presence of a body.

### BACKGROUND

Pressure or weight-sensitive floor mats are well-known in the art, and are used in a variety of applications. Conventional pressure or weight-sensitive floor mats generally comprise two conductive plates that make contact with each other to generate an alarm signal when pressure is applied to the mat. However, conventional pressure-sensitive mats include external connectors that protrude from the mat, for example, an electrical cord for connection to a power source, or an external connector for a wired, physical connection or a wireless connection to an alarm or doorbell. It is difficult to manufacture a conventional mat that is water-proof, since the mat cannot be completely sealed to protect electrical components internal to the mat from weather-related elements, e.g., rain, snow, and the like.

Further, a conventional pressure-sensitive mat is generally insufficiently thin to permit a conventional mat or rug, for example, a welcome mat, to be placed over the pressure-sensitive mat.

Also, the conductive plates of a conventional mat are generally inflexible metal plates, which render the mat inflexible and rigid, which is impractical in many applications. Also, metal plates are impractical when the mat requires many sensors in order to sense a presence at any point along the surface of the mat, which is expensive to manufacture.

Further, although conventional pressure-sensitive floor mats can sense the weight of a body applied thereon, an alarm signal is generated each time the pressure is applied to the mat, and the signal is not generated when the pressure is removed from the mat. However, there is no way to detect different pressure contact scenarios and to react within predetermined guidelines to prevent repeated alarming during a single event. For example, conventional mats lack the intelligence to detect how long a person or pet is standing on the mat and to disable an alarm signal when the person or pet is standing on the mat for an excessively long period of time. Conventional mats also lack the intelligence to temporally distinguish a person or pet that repeatedly steps on and off the mat as a single event, rather than as a series of independent events.

### SUMMARY

In accordance with aspects of the invention, a force-sensitive presence detector for use on a ground surface comprises a substantially flat water-proof enclosure, having disposed therein: an electrically isolating layer disposed between first and second conductive layers, wherein the electrically isolating layer has a plurality of contact regions formed therein to enable the first and second conductive layers to electrically couple in response to an application of a force thereto; and a signaling device configured to output a time-based signal to a receiver when the first and second conductive layers electrically couple in the at least one contact region.

In an embodiment, the detector further comprises a power source that provides power to the signaling device when the first and second conductive layers are electrically coupled.

In an embodiment, the receiver communicates with an audio device that generates a sound in response to receipt of the time-based signal, which may be programmable.

In an embodiment, the receiver is a wireless receiver, wherein the wireless receiver and the audio device form part of a wireless detection system.

In an embodiment, the time-based signal is transmitted for a predefined length of time that is independent of a duration of the application of the force.

In an embodiment, the detector is reset after the force is removed from the at least one contact region.

In an embodiment, the first and second conductive layers are flexible conductive films.

In an embodiment, the detector is configured to detect the presence of a pet.

In an embodiment, the detector is a pet training device.

In an embodiment, the pet training device is used to detect the presence of an animal at a door.

In an embodiment, the detector is configured to detect the presence of a human.

In an embodiment, the detector is positioned at a bedside or door side to detect a sleepwalker or wandering person.

In an embodiment, the detector is a security sensing device that is used to detect the presence of an intruder.

In an embodiment, the detector is configured as a security sensing device coupled to an alarm device.

In an embodiment, the detector is an undermat detector configured to be positioned beneath a door mat.

In an embodiment, the detector forms part of a doormat.

In an embodiment, the contact regions are distributed substantially throughout the water-proof enclosure.

In an embodiment, the water-proof enclosure comprises an elastomeric polyurethane or polyethylene material.

In an embodiment, the detector has a thickness of about 316 mils.

In an embodiment, the first and second conductive layers are adhered to an inner surface of the water-proof enclosure.

In an embodiment, the device generates one time-based signal per event.

In an embodiment, a single event includes a person or pet repeatedly stepping on and off the detector with short time-spans there between.

In accordance with other aspects, provided is a force-sensitive present detection system that comprises a force-sensitive presence detector, the detector comprising a substantially flat water-proof enclosure, having disposed therein: an electrically isolating layer disposed between first and second conductive layers, wherein the electrically isolating layer has a plurality of contact regions formed therein to enable the first and second conductive layers to electrically couple in response to an application of a force thereto; and a programmable signaling device configured to output a time-based signal to a receiver when the first and second conductive layers electrically couple; and an audio device that generates a sound in response to receipt of the time-based signal.

In accordance with other aspects, provided is a method of detecting a presence of a body. The method comprises providing a substantially flat presence detector comprising two conductive layers separated by an insulating layer having holes formed therein, the two conductive layers and insulating layer arranged in a water-proof enclosure; in response to a force applied to the presence detector, generating a time-based signal; generating an audible alarm in response to the time-based signal; and suppressing generation of a subsequent audible alarm when a subsequent force is applied to the presence detector within a predetermined period of time.

### BRIEF DESCRIPTION OF THE DRAWINGS

Example embodiments will be more clearly understood from the following detailed description taken in conjunction with the accompanying drawings. The drawings depict preferred embodiments by way of example, not by way of limitation. In the drawings, like reference numerals refer to the same or similar elements, wherein:

FIG. 1A is a view of an embodiment of a force-sensitive presence detection system, in accordance with some aspects of the present invention;

FIG. 1B provides two views of a force-sensitive presence detector positioned under a door mat, in accordance with some aspects of the present invention;

FIG. 2 is an oblique view of an embodiment of force-sensitive presence detector in accordance with some aspects of the present invention;

FIG. 3 is a cross-sectional view of the force-sensitive presence detector shown in FIG. 2, taken along line I-I′ of FIG. 2;

FIG. 4 is an oblique view of the force-sensitive presence detector of FIG. 2 illustrating an embodiment of internal elements of the detector, in accordance with some aspects of the present invention;

FIG. 5A is a first top view of the force-sensitive presence detector of FIG. 2 partially illustrating an embodiment of the interior of the detector, in accordance with some aspects of the present invention;

FIG. 5B is a second top view of the force-sensitive presence detector of FIG. 2 partially illustrating an embodiment of the interior of the detector, in accordance with some aspects of the present invention;

FIG. 6 is an expanded view of an embodiment of the audio device shown in FIG. 1A, in accordance with some aspects of the present invention; and

FIG. 7 is a flowchart depicting an embodiment of a method of detecting a presence of a body on a presence detector, in accordance with some aspects of the present invention.

### DETAILED DESCRIPTION OF EMBODIMENTS

Various example embodiments are described hereinafter with reference to the accompanying drawings. The present invention may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, example embodiments will be explained in detail with reference to the accompanying drawings.

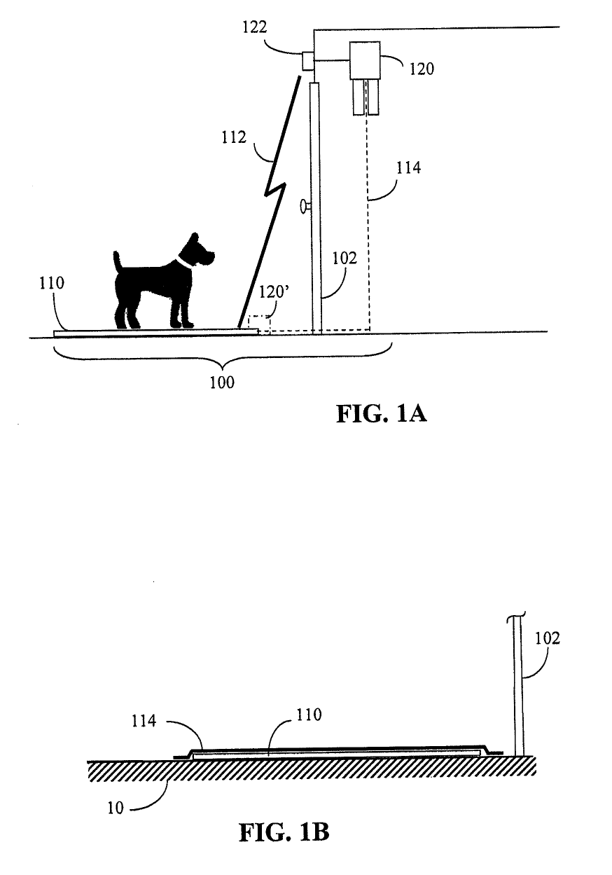

FIGS. 1A and 1B are views of embodiments of a force-sensitive presence detection system 100, in accordance with some aspects of the present invention. The force-sensitive detection system 100 includes a force-sensitive detector 110 and an output device 120. In the embodiment of FIG. 1A, the force-sensitive presence detector 110 is positioned near a door 102, and has the form of a doormat. In FIG. 1B the force-sensitive detector 110 is in the form of an “undermat,” e.g., a thin mat covered by a doormat, rug, or the like.

In FIG. 1A a dog is shown on detector 110, as an example. The force-sensitive presence detector 110 detects the presence of the dog and in turn generates a wireless detection signal 112 that is received by the output device 120. The output device could include a wireless receiver 122 that receives the wireless detection signal. The output device 120 is responsive to the received detection signal, to output a signal indicating the presence of a body on the force-sensitive detector 110. The output signal could be or include an audible signal, light signal, or data signal to another device (e.g., computer, phone, television, etc), or some combination thereof.

As will be discussed in further detail with respect to FIG. 6, when the output device 120 is an audio device 120, an audible signal can be generated, e.g., to alert a human of the presence of a body at the door. In FIG. 1A, for example, placement of the force-sensitive detector 100 outside a door could indicate that the dog wants to come in; placement of force-sensitive detector 100 inside the door could indicate that the dog wants to go out.

The detector 100 communicates a signal indicating the presence of a body applying a force to the detector 100. In FIG. 1A, the detector 110 communicates via a wireless path 112 to the audio device 120. In another embodiment, the detector 110 can be directly or indirectly connected to a remote audio device 120 via a physical connection, such as a wired connection (indicated by dashed line 114). In another embodiment, the audio device 120 can be part of the detector 110, and the audio device 120 can be co-located with the detector 100 in a single package (as indicated by dashed box 120′).

In another embodiment, as shown in cross-sectional side view of FIG. 1B, the detector 110 can be positioned under a door mat 114 or throw rug as an undermat, such that the detector 110 is positioned between the door mat 114 and a ground surface 10. While the embodiment shown in FIG. 1B shows a door mat 114 positioned over the detector 110, other coverings may be used, such as a throw rug or pad. In other embodiments, the detector 110 can be positioned in, or form part of, a home rug. In other embodiments, the detector 110 can be placed on a ground surface with no covering (e.g., mat or rug) placed over it, as shown in FIG. 1A.

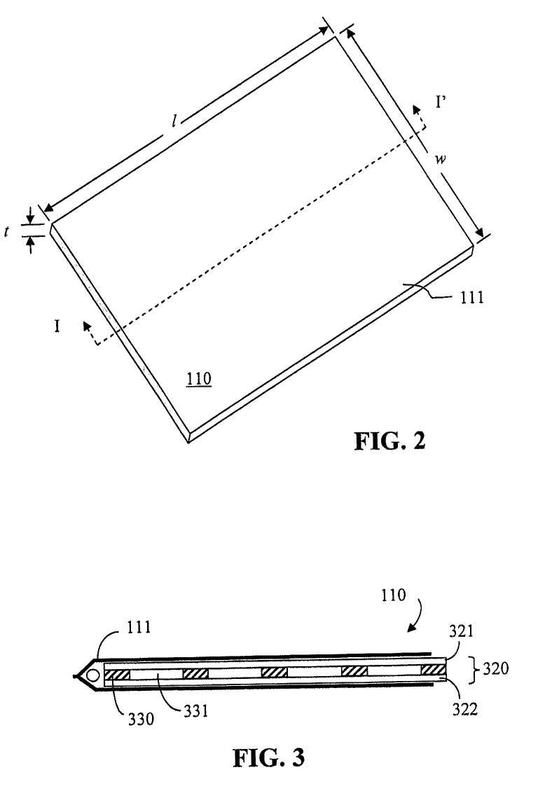

FIG. 2 is an oblique view of an embodiment of force-sensitive presence detector 110 in accordance with some aspects of the present invention. In this embodiment, the force-sensitive presence detector 110 has a compact, substantially flat configuration. That is, the detector 110 has a small thickness (t) relative to a width (w) and a length (l) of the detector 110. In an embodiment, the thickness (t) of the detector 110 is preferably about ¼ inch or less, or 316 mils or less, although greater thicknesses may be suitable in various embodiments. In some embodiments, e.g., for use in a doorway, the width (w) of the detector 110 is approximately 24 inches and the length (l) of the detector 110 is approximately 36 inches. Again, the detector is not limited to such dimensions.

Preferably, the detector 110 comprises thin materials that achieve high flexibility properties, and permit the detector 110 to be durable and resistant to tears or scratches, and permit the detector 110 to be placed outdoors, regardless of weather, such as rain or snow, or hot or cold weather.

The detector 110 includes a durable enclosure 111 that is completely sealed, such that no external components, for example, wires, power sources, antennas, or other electrical circuits, externally protrude from the detector 110. This eliminates the need for users to hide these external components when placing the detector 110 in an operational environment and reduces the vulnerability of damage to those components. For example, a user can place the detector 110 in front of a door, without the need to tuck external wiring inside a door molding, and without the need to make any external connections, for example, to an external power supply or antenna. The enclosure 111 can also protect these components from external elements, such as rain, snow, etc., which can otherwise damage these components, particularly when constructed for outdoor use.

In this embodiment, the enclosure 111 can comprise a single layer of material that encloses or otherwise surrounds the other components of the detector 110, for example, the conductive layers, wiring, power source, wireless transmitter, antenna, and the like, each described in detail below. In another embodiment, the enclosure 111 can include two or more layers of material that are attached to each other, wherein the other components of the detector are sandwiched between the layers of material. In some embodiments, the layers of material or the edges of a single sheet of material can be sealed together by heat-sealing to prevent water from leaking through the seal and damaging the components surrounded by the enclosure 111 and to provide additional durability. Other forms of sealing can be used in other embodiments, such as water-proof sealants or adhesives.

The enclosure 111 comprises durable materials that can prevent tearing or penetration. For example, the enclosure 111 can include one or more sheets of plastic material, for example, flexible elastomeric polyurethane or polyethylene plastic sheet of material, or other materials that permit the enclosure to be thin, flexible, and durable, as well as weather-proof or water-resistant. In an embodiment, the enclosure 111 can comprise recycled materials, for example, recycled plastics. In an embodiment, the enclosure can comprise biodegradable materials, or other materials known to those of ordinary skill in the art as being environment-friendly, e.g., reducing pollution and saving energy. In an embodiment, the enclosure 111 comprises a flexible, durable plastic outer coating, such as elastomeric polyurethane or polyethylene, or other materials that are resistant to tearing, scratching, or inclement weather.

In the present embodiment, the enclosure 111 can have a thickness of approximately 0.020 mils or 0.508 millimeters, which permits the enclosure 111 to be sufficiently resilient to tearing, ripping, perforating, or other types of damage the enclosure. The enclosure 111 is preferably configured to permit a wireless signaling device or transmitter internal to the enclosure 111 to generate an effective time-based signal through the enclosure to an external wireless receiver, even when the enclosure is wet or frozen due to inclement weather or other environmental conditions.

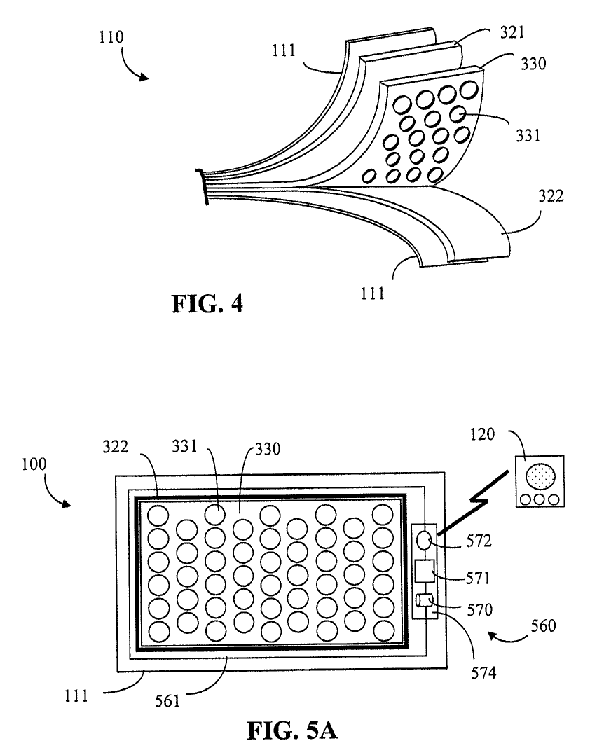

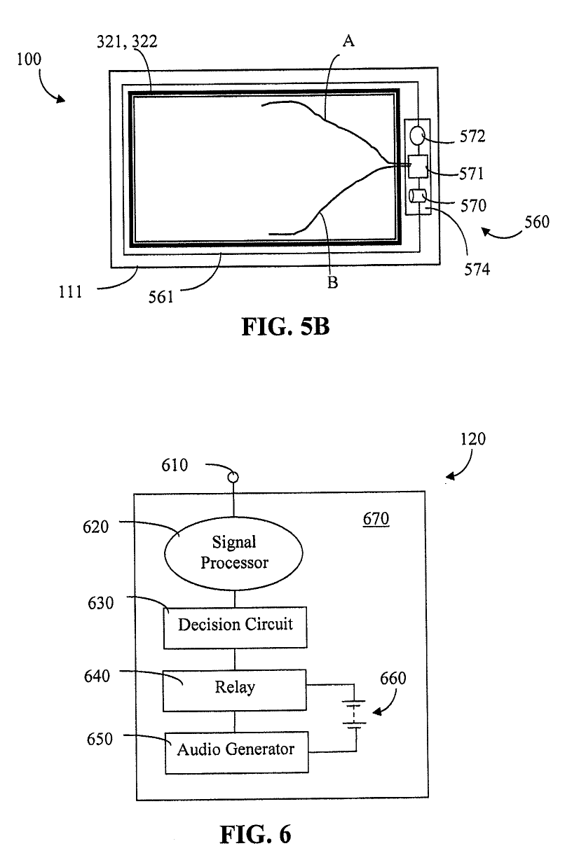

FIG. 3 is a cross-sectional view of the force-sensitive presence detector 110 shown in FIG. 2, taken along line I-I′ of FIG. 2. FIG. 4 is an oblique view of the force-sensitive presence detector of FIG. 2 illustrating an embodiment of internal elements of the detector, in accordance with some aspects of the present invention. FIG. 5A is a first top view of the force-sensitive presence detector of FIG. 2 partially illustrating an embodiment of the interior of the detector, in accordance with some aspects of the present invention. FIG. 5B is a second top view of the force-sensitive presence detector of FIG. 2 partially illustrating an embodiment of the interior of the detector, in accordance with some aspects of the present invention.

Referring to FIGS. 3 and 4, in this embodiment, the detector 110 comprises an electrically isolating layer 330, which can also be referred to as a dielectric layer, disposed between a set of conductive layers 320, here including first conductive layer 321 and a second conductive layer 322, and electrically separating the first and second conductive layers 321 and 322 from each other when little or no force is applied to the surface of the detector 110. In various embodiments, at least one of the first conductive layer 321 and the second conductive layer 322 comprises a flexible, pliable, or bendable conductive material, allowing the detector 110 to be flexible, pliable, or bendable.

In an embodiment, the first and second conductive layers 321, 322 are formed of a thin aluminum layer, for example, an aluminum foil. In an embodiment, the aluminum layers 321, 322 are about 0.020 mils thick. In other embodiments, the conductive layers 321, 322 can be formed of one or more other conductive materials, such as metals or metal alloys or other conductive materials known to those of ordinary skill in the art.

In some embodiments, one or both of the first conductive layer 321 and the second conductive layer 322 can be attached to an inner surface of the enclosure 111. But in other embodiments, such attachment is not required.

In the present embodiment, the isolating layer 330 comprises a compressible material, such as a compressible foam-based material. In various embodiments, in an uncompressed state, the isolating layer 330 can have a thickness ranging from about 0.2 inches to about 0.5 inches, or other thicknesses depending on the desired compression properties of the isolating layer 330. Here, in FIGS. 3 and 4, the first and second conductive layers 321, 322 and the isolating layer 330 have a combined thickness of about 0.2 inches or less in an uncompressed state. For example, a detector configured and arranged to support the weight of an adult person can include an isolating layer having a higher resiliency and less compression than an isolating layer configured to support the weight of a dog. Regardless of the compression properties of the isolating layer 330, the isolating layer 330 is chosen to be sufficiently compressible to permit the first and second conductive layers 321 and 322 positioned on first and second sides of the isolating layer 330 to contact each other when a force above a predetermined amount is applied to the detector 110. Also, if the detector 110 is constructed to be under a rug or mat, the isolating layer 330 can be chosen to be thinner than if the detector 110 is constructed to be used as an independent unit, upon which a person and/or animal can step on directly.

In this embodiment, there are a plurality of contact holes 331 formed in the isolating layer 330 to enable the first and second conductive layers 321, 322 to electrically couple when a force, such as a weight, is applied to the detector 110. In some embodiments, the isolating layer 330 can have an array of contact holes 331, which can be about equally spaced from each other as in FIG. 5A. The contact holes 331 are spaced apart at about regular intervals and have about the same width in this embodiment. In other embodiments, however, the contact holes 331 can be spaced apart by different intervals and have different widths. The contact holes 331 are circular in the present embodiment, but can have different shapes, such as ovals, lines, polygons, etc. Therefore, the contact holes 331 can be the same size and shape, or be of different sizes and shapes. For example, contact holes 331 positioned about a perimeter of the isolating layer 330 can have a different shape, size, or other dimensions than contact holes 331 positioned proximal to a center region of the isolating layer 330. In the embodiment of FIGS. 3, 4, and 5A, the contact holes are circles formed by perforating the isolating layer 330 with 1.5 inch diameter or width cut-outs, with a separation of 0.5 inches between cut-outs, in directions along the width (w) and length (l) of the isolating layer 330.

In the embodiment of FIG. 5A, the detector 110 is shown with the first conductive layer 321 and top of the enclosure 111 removed. Detector 110 includes a programmable signaling device 560 and a power source 570, which are enclosed and protected by the enclosure 111. As shown in FIGS. 5A and 5B, the signaling device 560 can comprise a wireless transmitter 572, described in detail below, which outputs signals generated by the detector 110 to an external output device 120, such as an alarm or audio device. The signaling device 560 can further comprise a switch circuit 571 that provides power from the power source 570 to the conductive layers 321, 322 via wire, e.g., a flexible, multi-stranded core wire 576. As shown in FIG. 5B, in the present embodiment, at least one of the conductive layers 321, 322 is connected to the signaling device 560 by flexible conductive wiring 576, where wire “A” can connect to first conductive later 321 and wire “B” can connect to second conductive layer 322.

In the present embodiment, the power source 570 is a battery that forms part of the signaling device 560. In another embodiment, the power source 570 can be external to the signaling device 560, and need not be a battery. In the present embodiment, the detector 110 generates a time-based signal, which includes information comprising at least one time-based parameter, such as at least one of an event start time, end time, duration, etc.

One of the first and second conductive layers 321, 322 is configured to have a first polarity (for example, a positive polarity), and the other of the first and second conductive layers 321, 322 is configured to have a second, opposite polarity (for example, a negative polarity). An electrical circuit can be formed between the power source 570, the first and second conductive layers 321, 322, and the signaling device 560 when the first and second conductive layers 321, 322 are in electrical contact with each other. When the electrical circuit is completed in such a manner, the signaling device 560 can enter a detecting state, permitting signals to be output from the detector 110.

During operation, a person or animal applies a weight to the detector 110, which compresses the insulating layer 330, wherein the first and second conductive layers 321, 322 make electrical contact with each other, resulting in a signal being sent, e.g., via core wire 576 shown in FIG. 5B, to the signaling device 560. Using a current of the completed circuit formed when conductive layers 321, 322 come into contact, the signaling device 560, which can be integrated into a radio microprocessor chip (not shown), enables the detector 110 to transmit a signal to an external device, such as remote audio device 120, or other commercial off-the-shelf device, such as a doorbell system, alarm system, or cell phone. This transmission can be accomplished, for example, wirelessly using an FCC-approved, unlicensed radio frequency band, or other frequencies or spectrums known to those of ordinary skill in the art.

In response, the audio device 120 produces an alarm (e.g., sound, sound pattern. signal) indicating that the detector 110 has detected the presence of a body. In other words, the alarm indicates that an event is occurring, such as a pet desiring to leave or return to a home, or a wandering person, for example, a sleepwalker, or a person requiring the supervision of a guardian or caretaker, for example, a person suffering from Alzheimer's disease.

In an embodiment, the alarm event is reset when the body steps off or is otherwise removed from the surface of the detector 110, causing the electrical contacts between the conductive layers 321, 322 via contact holes 331 to be removed due to the expansion or decompression of the isolating layer 330. If at least one electrical contact continues to exist, the event will not be cleared, in the present embodiment. Accordingly, as will be discussed in further detail below, the detector 110 can be configured to comply with rules (or intelligent algorithms) for alarm generation and resetting. For example, such rules can require that all electrical contacts are removed prior to resetting the detector 110 to process another event. In various embodiments, the detector 110 can include software stored in a non-transitory medium (e.g., computer chip memory) executable by at least one processor to perform various rules-oriented functions.

In some embodiments, different regions of the detector 110 can be distinguished. For example, rather than two parallel conductors (i.e., first conductive layer 321 and second conductive layer 322), there can be a plurality of pairs of parallel conductors, wherein one or more pairs of parallel conductors can form a region. In such embodiments, with its four paws a dog can provide four separate contact points on the detector 110, e.g., via four different contact holes 331 or points. The different contact points can be processed as different contact regions. A person, on the other hand, in another event can provide two separate contact points or regions, via contact holes 331, when both feet are on the detector 110. Depending on the embodiment, a plurality of adjacent contacts can be interpreted as a single contact region or point.

The signaling device 560 can be programmed, either by a user or at the time of manufacturing, to distinguish between these two different types of events—e.g., animal versus person—based on the number of contact points or regions. As with embodiments discussed below, in such an embodiment, the detector 110 can also respond to repeated or intermittent contacts made by the dog or person during a single event, for example, during a period of time between the time that the dog or person steps on the detector 110 and the time that the dog or person leaves the detector 110.

The signaling device 560 can comprise a multi-layer printed circuit board (PCB) 574, including electronic circuits, such as the abovementioned transmitter 572 and switch circuit 571, as well as a memory device (not shown). In addition, the signaling device 560 can comprise a signal processor, such as a radio processor, and an antenna. The PCB can be formed of a flexible materials and have a low profile. The antenna can be formed of a flexible conductive material. The antenna can be an embedded antenna 561, for example, as shown in FIG. 5A, which surrounds inner layers of the device, for example, the first and second conductive layers 321, 322. Or, as shown in FIG. 5B, the antenna 562 can extend from the circuit 560, but also be surrounded by the enclosure 110.

The signaling device 560 can include a wireless transmitter 572 that communicates with a wireless receiver of the output device 120 (e.g., a doorbell, alarm, or computer). In other embodiments, the signaling device 560 can be directly wired to at least one of doorbell, alarm, or computer that is either external to the detector 110, or is included in the detector 110, for example, enclosed by the enclosure 111. In the abovementioned embodiments, the signaling device 560 transmits signals when electrical contact is made between the first and second conductive layers 321, 322 via one or more contact holes 331 of the isolating layer 330.

In the present embodiment, the signaling device 560 can comprises custom software, which can be used to implement the program logic and rules described herein related to an output signal (e.g., detection or alarm generation and reset). For instance, when executed by a processor, the custom software enables the signaling device 560 to generate time-based signals to audio device 120. In one embodiment, when an event is sensed by the detector 110 the signaling device 560 processes the event, based on data such as start time of the event, time duration of contact between conductive layers 321, 322, and/or time period since prior contact, and transmits at least one time-based signal to the audio device 120 based on such data. Some or all of this time-based information can be transmitted by the signaling device 560 and used by alarm generation and/or reset logic. In various embodiments, the signal can comprise information pertaining to a duration or length of time that an alarm or sound is to be generated. In yet another embodiment, the signal can comprise reset instructions so that the external device can be reset to generate alarms (e.g., tones, chimes, etc.) in response to a new event.

Preferably, once pressure is applied to the detector 110, resulting in the triggering of an alarm at audio device 120, for example, any furthering triggering of signals to the audio device 120 is ceased by the signaling device 560 until all pressure has been removed from the detector 110 for a predetermined duration of time. In some embodiments, the duration of time is can be 30-60 seconds, or longer. In the present embodiment, automatic resetting of the signaling device 560 occurs after pressure has been released, so that the first and second conductive layers 321, 322 are no longer in electrical contact, and the programmed duration of time has been exhausted. If at least one electrical contact between conductive layers 321, 322 remains, the event will not be cleared, and the reset will not occur. In other embodiments, reset can occur after a predetermined amount of time after initial contact of the first and second conductive layers 321, 322.

In some embodiments, the signaling device 560 can reset the detector 110, whereby the detector 110 can detect a new event, if contact between the two conductive layers 321, 322 of the detector 110 exceeds a predetermined time, as described above. In an embodiment, the signaling device 560 can avoid repeat alarming of the same event when pressure is removed from the detector 110, wherein the device 560 is reset, and enters a standby state to detect a new event.

The force-sensing presence detector system 100 can be configured to recognize and respond to different contact scenarios, by implementing a set of contact scenario logic. The logic can be stored at, and executed by, the detector 110 (e.g., in the abovementioned memory device), output (or audio) device 120, or some combination thereof.

In some embodiments, the signaling device 560 can be configured to process different pressure contact scenarios. In such cases, the signaling device 560 can transmit signals in accordance with predetermined and programmed response logic to prevent alarms (e.g., sounds or sound patterns) from being repeated during a single event, as an example.

In various contact scenarios the alarm (e.g., sound or sound pattern) can be produced by the audio device 120 when the force is first detected by the detector 110. In the preferred embodiment, the audio device 120 will stop producing the sound if the force continues to be applied beyond the predetermined period of time. For example, in one embodiment, if a person stood on the detector 110 for four minutes, the alarm would only be initially generated and then cease—rather than continuing for the entire four minutes. In other embodiments, if the event persisted for several minutes, the alarm could be generated periodically during the event, e.g., every two minutes during the single event for up to about five seconds each time.

One example contact scenario occurs when a person or animal stands on the detector 110 for at least a predefined period of time. Another example contact scenario occurs when a person or animal repeatedly steps on and off the detector 110 in quick succession. Another example contact scenario occurs when a pet steps on the detector 110 with a first paw, then subsequently steps on the detector 110 with a second paw, etc.

For example, signaling device 560 can determine a person or animal repeatedly stepping on and off the detector 110 in quick succession as a single event, as distinguished from multiple events, and generate an alarm via audio device 120 accordingly. There are different approaches that can be used for generating or sounding the alarm in such a contact scenario. For example, when forces are applied to detector 110 in quick succession, such as a pet stepping on the detector 110 with more than one paw (i.e., separate forces close in time), the alarm generated from the detection will not reset until a predetermined amount of time after the first detection has lapsed. In this manner, the audio device 120 does not generate multiple alarms, i.e., an alarm for each paw being positioned on the detector 110. In an alternative embodiment, the alarm is reset after a predetermined amount of time after the last detection has elapsed.

Thus, there are various approaches to resetting the alarm, which can differ depending on the contact scenario. Reset could be implemented as the detector 110 resetting, the audio device 120 resetting, or both resetting. In one embodiment, when the force is removed from the detector 110, the force-sensitive presence detection system 100 is reset. In another embodiment, the detector 110 is reset a predetermined amount of time after a presence is detected on the detector 110. Once reset has occurred, an alarm or output is next generated when another force applied to the detector 110 is detected, i.e., during a different event.

In an environment where there are multiple detectors 110, one or more of the detectors can have an address (or other identifier). The address can also be transmitted by the signaling device 560 to the audio device 120, e.g., embedded within the time-based signal generated in response to detection of an event. The transmitted signal can, therefore, include information related to the event, such as start time, duration, etc., as well as an identification address of the transmitting detector 110. Thus, in an environment where there are multiple detectors that are proximate to each other, for example, multiple detectors distributed about a home, a triggering detector 110 from a plurality of detectors 110 can be distinguished from the other detectors in the plurality of detectors by an identification address. A response, or generated alarm, can be focused to the detector 110 from where the signal was transmitted. For example, each of the plurality of detectors could have a different alarm (e.g., sound or sound pattern) associated therewith.

In other embodiments, the logic for controlling the alarm and reset can be in output device 120, and the detector 110 can passively transmit signals in response to any applied force.

FIG. 6 is an expanded view of an embodiment of the output device 120 shown in FIG. 1A, as an audio device 120, in accordance with some aspects of the present invention. The audio device 120 can receive a signal transmitted by the detector 110 and produce a predefined alarm (e.g., sound or sound pattern) that can be used to notify others of the presence of a person or animal on the detector 110, as described above.

In the embodiment shown in FIG. 1A, the detector 110 can wirelessly communicate with remote audio device 120, which can include a microprocessor chip, for example, a radio microprocessor chip. In those embodiments in which the detector 110 and the audio device 120 are in wireless communication with each other, the audio device 120 can be programmed to communicate with the detector 110 at a frequency permitting such communication, for example, an FCC approved, unlicensed radio frequency band, or other frequencies known to those of ordinary skill in the art.

The audio device 120 shown in the example embodiment of FIG. 6 includes a signal processor 620 coupled to an antenna 610, a decision circuit 630, a relay circuit 640, an audio generator 650, and a power source 660. In an embodiment, one or more of the abovementioned components of the audio device 120 can be formed on a multi-layer printed circuit board (PCB) 670. In an embodiment, the audio device 120 can be configured to be in a single package composed of durable and shock resistant plastic, or the like.

The audio generator 650 can include circuitry that generates alarms, such as chimes, tones, etc., or other preprogrammed sounds or patterns. The audio generator 650 can also include memory that stores sounds, such as chimes, tones, recordings, or other sounds, such as ringtones, etc.

In an embodiment where the detector 110 can be uniquely identified, e.g., where there are a plurality of detectors, the detector 110 can output to the audio device 120 a signal that includes a unique address. The audio device 120 can include a table of addresses, and can verify the address of a received signal through comparison with the on-board table of addresses. If the address is verified, the audio device 120 can then trigger an electromechanical relay or electric relay 640 to activate the audio circuit 650 for alarm production.

In some embodiments, the signal processor 620 comprises a radio microprocessor that receives the abovementioned signals from the detector 110 via the antenna 610, or other wireless receiver. In other embodiments, the signal processor 620 can receive the abovementioned signals from the detector 110 via a wired connection. The detector 110 can be “paired” with the audio device 120, such that the devices are known to each other. When the detector 110 sends a signal, it is received via a port of the relay circuit 640 on the PCB of the audio device 120, and ultimately triggers electronic circuitry of the audio device 120. The received signal can be converted by the signal processor 620 into either analog or digital format, depending on the signal processing arrangement of the audio device 120.

Once the signals have been received and verified by the audio device 120, the decision circuit 630 activates the audio generator 650 via the relay circuit 640, wherein the audio generator 650 produces an alarm, e.g., such as a chime, tone or other sounds commonly used in doorbell or alarm system configurations. The relay circuit 640, which is typically open in a standby state, will then be closed, thereby forming a closed circuit in a detecting state. When the circuit is closed, an alarm (e.g., a sound or sound pattern) is generated by the audio generator 650. The audio generator 650 can be capable of producing a variable number of alarms (e.g., sounds and sound patterns), which could be pre-programmed and stored on the output device 120. In some embodiments, the sounds and patterns can be user-created or customized.

In the present embodiment, the power source 660 is a battery. But in other embodiments, the power source 660 can comprise an AC/DC converter to convert power from a standard electrical outlet.

In an embodiment, the audio device 120 can be attached to a wall or other surface.

In another embodiment, the audio device 120 can communicate with an existing doorbell or alarm that is attached to a home or business. In another embodiment, the audio device 120 can be portable, and can be carried by a person to different locations. In another embodiment, the audio device 120 can be integrated with the detector 110, for example, co-located with the components of the detector 110 and likewise surrounded by the enclosure of the detector.

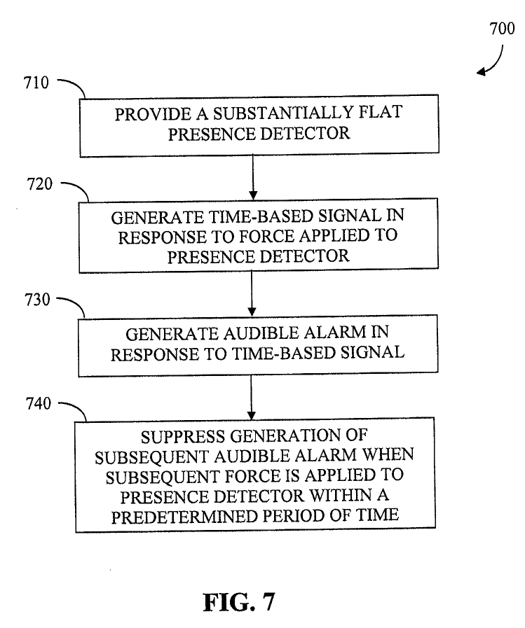

FIG. 7 is a flowchart 700 depicting an embodiment of a method of detecting a presence of a body on a detector, e.g., detector 110.

In step 710, a substantially flat presence detector is provided. In this embodiment, the presence detector comprises two conductive layers separated by an insulating layer having holes formed therein. The conductive layers and insulating layer are arranged in a water-proof enclosure. Next, as illustrated in step 720, in response to a force applied to the presence detector, a time-based signal is generated. As illustrated in step 730, an audible alarm is then generated in response to the time-based signal. As illustrated in step 740, generation of a subsequent audible alarm can be suppressed when a subsequent force is applied to the presence detector within a predetermined period of time.

As described above, embodiments of the present invention include a wireless force-sensor detection system, detector, and audio (or alarm) device. When pressure is applied to the detector, a time-based signal is sent from the detector to a receiving audio device to create an alarm to notify a person to act or that an event is occurring. Uses for the system can include notifying a person that a pet must be let out to relieve itself or to return inside, or that a person is wandering about an environment, for example, a sleepwalker, or to notify a guardian or caretaker of a person requiring supervision, such as a parent of a child or a caretaker of an elderly person, that the person is wandering about the home, or to alert a homeowner that a person is approaching their door—as examples. Another application is that the system can be a security sensor, whereby the detector is positioned outside a door or window, and generates an alarm when an intruder attempts to enter a home or business through the door or window.

While embodiments illustrating the present invention have been particularly shown and described with reference to exemplary drawings hereof, it will be understood by those of ordinary skill in the art that various changes in form and details may be made therein without departing from the spirit and scope of the invention.

What is claimed is:

1. A force-sensitive presence detector for use on a ground surface, comprising:
a substantially flat water-proof enclosure, having disposed therein:
an electrically isolating layer disposed between first and second conductive layers, wherein the electrically isolating layer has a plurality of contact regions formed therein to enable the first and second conductive layers to electrically couple in response to an application of a force thereto; and
a signaling device configured to output a time-based signal to a receiver when the first and second conductive layers electrically couple in the at least one contact region.

2. The detector of claim 1 further comprising:
a power source that provides power to the signaling device when the first and second conductive layers are electrically coupled.

3. The detector of claim 1, wherein the receiver is configured to communicate with an audio device that generates a sound in response to receipt of the time-based signal.

4. The detector of claim 3, wherein the receiver is a wireless receiver, and wherein the wireless receiver and the audio device form part of a wireless detection system.

5. The detector of claim 1, wherein the time-based signal is transmitted for a predefined length of time that is independent of a duration of the application of the force.

6. The detector of claim 1, wherein the detector is reset after the force is removed from the at least one contact region.

7. The detector of claim 1, wherein the first and second conductive layers are flexible conductive films.

8. The detector of claim 1, wherein the detector is configured to detect the presence of a pet.

9. The detector of claim 1, wherein the detector is configured to detect the presence of a human.

10. The detector of claim 1, wherein the detector is configured as a security sensing device coupled to an alarm device.

11. The detector of claim 1, wherein the detector is an undermat detector configured to be positioned beneath a door mat.

12. The detector of claim 1, wherein the detector forms part of a doormat.

13. The detector of claim 1, wherein the contact regions are distributed substantially throughout the water-proof enclosure.

14. The detector of claim 1, wherein the water-proof enclosure comprises an elastomeric polyethylene material.

15. The detector of claim 1, wherein the detector has a thickness of not more than about 316 mils.

16. The detector of claim 1, wherein the first and second conductive layers are adhered to an inner surface of the water-proof enclosure.

17. The detector of claim 1, wherein the device generates one time-based signal per event.

18. The detector of claim 18, wherein a single event includes a body repeatedly stepping on and off the detector with predetermined time period.

19. A detection system comprising:
a force-sensitive presence detector, the detector comprising a substantially flat water-proof enclosure, having disposed therein:
an electrically isolating layer disposed between first and second conductive layers, wherein the electrically isolating layer has a plurality of contact regions formed therein to enable the first and second conductive layers to electrically couple in response to an application of a force thereto; and
a programmable signaling device configured to output a time-based signal to a receiver when the first and second conductive layers electrically couple; and
an output device that generates a sound in response to receipt of the time-based signal.

20. A method of detecting a presence of a body, the method comprising:
providing a substantially flat presence detector comprising two conductive layers separated by an insulating layer having contact regions formed therein, the two conductive layers and insulating layer arranged in a water-proof enclosure;
in response to a force applied to the presence detector, generating a time-based signal;
generating an audible alarm in response to the time-based signal; and
suppressing generation of a subsequent audible alarm when a subsequent force is applied to the presence detector within a predetermined period of time.
